(19) United States
(12) Patent Application Publication
(10) Pub. No.: US 2004/0119862 A1
(43) Pub. Date: Jun. 24, 2004

(54) Image sensor capable of radiating heat rapidly

(76) Inventors: Jackson Hsieh, Hsinchu Hsien (TW); Jichen Wu, Hsinchu Hsien (TW)

Correspondence Address: PRO-TECHTOR INTERNATIONAL, 20775 Norada Court, Saratoga, CA, 95070-3018, US

(21) Appl. No.: 10/321,916

(22) Filed: Dec. 16, 2002

(51) Int. Cl. H04N 5/225; H04N 5/335

(52) U.S. Cl. 348/294; 348/340

(57) ABSTRACT

An image sensor includes a substrate, a frame layer, a photosensitive chip, a plurality of wires, and a transparent layer. The substrate consists of a middle board and a plurality of spaced, symmetrical metal sheets arranged at two sides of the middle board. Each metal sheet includes a first board and a second board positioned at different heights. The horizontal height of the middle board is lower than that of the first board. The frame layer encapsulates the metal sheets and the middle board with the first boards, second boards and middle board of the metal sheets exposed from the frame layer. The second board is electrically connected to the printed circuit board. The photosensitive chip is positioned on the middle board of the substrate. The wires electrically connect the first boards to the photosensitive chip. The transparent layer is positioned on the frame layer to cover the photosensitive chip.

### BACKGROUND OF THE INVENTION

1. Field of the Invention

The invention relates to an image sensor structure capable of radiating heat rapidly, and in particular to an image sensor that is easy to be fabricated and capable of increasing the production yields.

2. Description of the Related Art

Referring to FIGS. 1 and 2, a conventional package structure for a photosensitive chip is manufactured according to the following steps. First, a substrate 10, on which traces 12 are formed to define a plurality of zones 17, is provided. Then, a plurality of photosensitive chips 13 is arranged in the plurality of zones 17. Next, a frame layer 14 formed with a plurality of slots 16 corresponding to the traces 12 is adhered onto the substrate 10 through an adhesive layer 15. At this time, the photosensitive chips 13 on the substrate 10 are exposed via the slots 16. Then, a plurality of wires 18 is provided to electrically connect the photosensitive chips 13 to the substrate 10. Next, the substrate 10 is cut into package bodies each including the frame layer 14, as shown in FIG. 2. Then, as shown in FIG. 3, a single package body is placed within a jig 22, and a zone for receiving a piece of transparent glass 20 is defined. Next, the transparent glass 20 is adhered to the frame layer 14 through the adhesive layer 24 to cover the frame layer 14 so as to finish the package processes of the photosensitive chips 13.

The conventional image sensor has the following drawbacks to make its package cost high.

1. The substrate 10 has to be manufactured in advance. Then, the traces 12 are formed on the substrate 10. Subsequently, the frame layer 14 is bonded to the substrate 10. Therefore, the manufacturing processes are relatively complicated and the material cost is also high, thereby increasing the overall manufacturing costs.

2. After having been packaged, the image sensors have to be cut into individual package bodies. Since the frame layer 14 is bonded to the substrate 10 by the adhesive layer 15, the adhesive layer 15 tends to overflow during the cutting process, thereby influencing the signal transmission effects.

3. The process for covering the transparent glass 20 is performed after the substrate 10 is cut, the photosensitive chips 13 are easy to be contaminated by the cutting chips. As a result, the yield of the photosensitive chips 13 is adversely influenced.

In view of the above-mentioned problems, the invention provides an image sensor capable of improving the drawbacks to make the image sensor more practical.

### SUMMARY OF THE INVENTION

An object of the invention is to provide an image sensor structure capable of radiating heat rapidly, simplifying the package processes, and lowering the manufacturing costs.

Another object of the invention is to provide an image sensor structure capable of radiating heat rapidly, increasing the production yield, and lowering the package cost.

Still another object of the invention is to provide an image sensor structure capable of radiating heat rapidly, wherein the image sensor is made small, light, thin and short and is more practical accordingly.

Yet still another object of the invention is to provide an image sensor structure capable of radiating heat rapidly and thus extending the lifetime of the product.

To achieve the above-mentioned objects, an image sensor for being connected to a printed circuit board is provided. The image sensor includes a substrate, a frame layer, a photosensitive chip, a plurality of wires, and a transparent layer. The substrate consists of a middle board and a plurality of spaced, symmetrical metal sheets arranged at two sides of the middle board. Each of the metal sheets includes a first board and a second board positioned at different heights. The horizontal height of the middle board is lower than that of the first board. The frame layer encapsulates the plurality of metal sheets and the middle board with the first boards, second boards and middle board of the metal sheets exposed from the frame layer. The second board is electrically connected to the printed circuit board. The photosensitive chip is positioned on the middle board of the substrate. The wires electrically connect the first boards of the metal sheets to the photosensitive chip. The transparent layer is positioned on the frame layer to cover the photosensitive chip.

### BRIEF DESCRIPTION OF THE DRAWINGS

FIG. 1 is an exploded view showing a conventional image sensor structure.

FIG. 2 is a first schematic illustration showing the conventional image sensor structure.

FIG. 3 is a second schematic illustration showing the conventional image sensor structure.

FIG. 4 is a cross-sectional view showing the combined image sensor structure capable of radiating heat rapidly according one embodiment of the invention.

FIG. 5 is a cross-sectional view showing the combined image sensor structure capable of radiating heat rapidly according another embodiment of the invention.

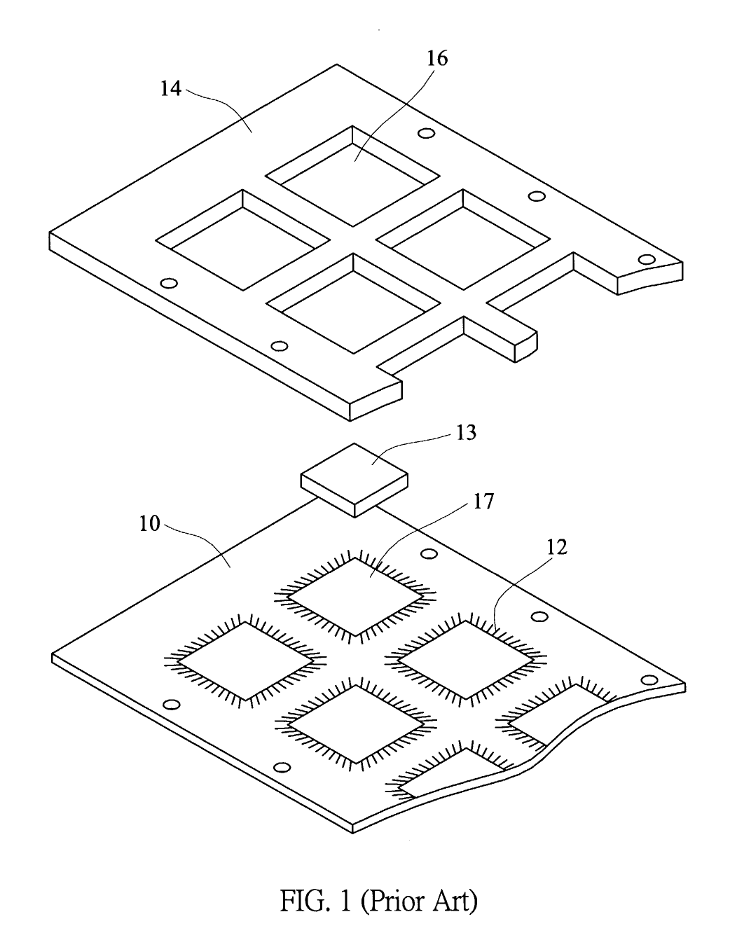

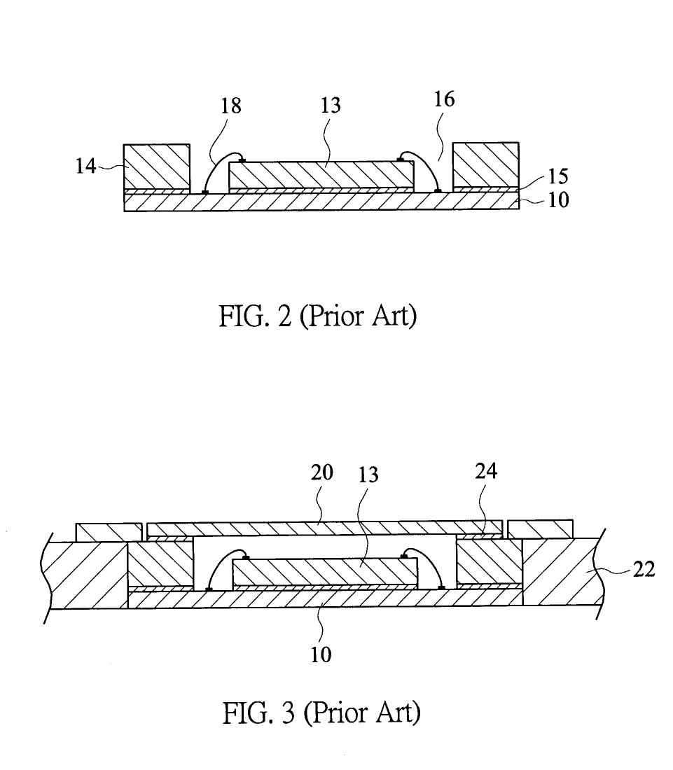

### DETAILED DESCRIPTION OF THE INVENTION

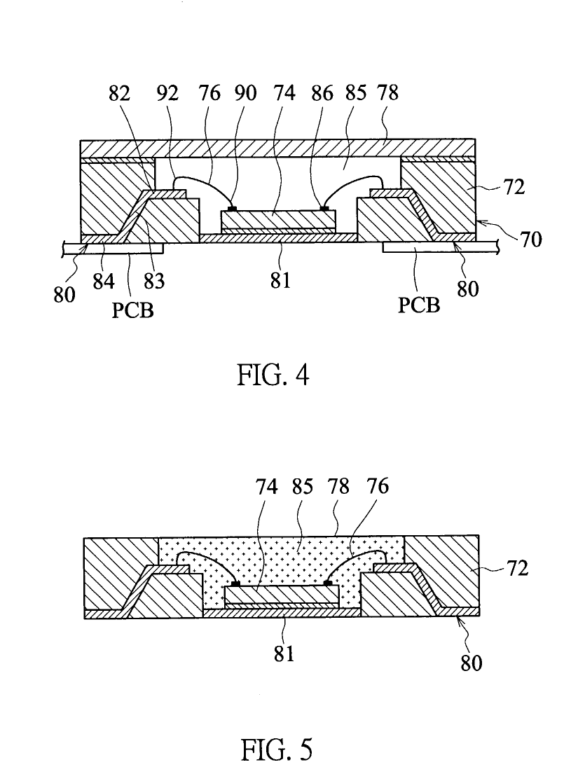

Referring to FIG. 4, an image sensor of the invention includes a substrate 70, a frame layer 72, a photosensitive chip 74, a plurality of wires 76 and a transparent layer 78.

The substrate 70 is consisted of a middle board 81 and a plurality of metal sheets 80, which is formed by punching and pressing the metal material, and is spaced apart and arranged symmetrically at two sides of the metal sheets 80. Each metal sheet 80 includes a first board 82 and a second board 84 located at different heights, and further includes a third board 83 connecting the first board 82 to the second board 84. The middle board 81 is positioned at a horizontal height lower than that of the first boards 82. In this embodiment, the middle board 81 is positioned at a horizontal height the same as that of the second boards 84. The second boards 84 are electrically connected to a printed circuit board PCB to transfer signals from the second boards 84 to the printed circuit board PCB.

The frame layer 72 is formed from the thermoplastic material by way of injection molding and is formed into a U-shaped structure together with the metal sheets 80. Thus, a frame structure is formed at the periphery of the substrate 70, and a cavity 85 is formed above the middle board 81. The frame layer 72 encapsulates the metal sheets 80 with the first boards 82 and the second boards 84 of the metal sheets 80 exposed. Meanwhile, the bottom surface of the middle board 81 is also exposed. That is, the frame layer 72 does not encapsulate the upper surfaces of the first boards 82 and the lower surfaces of the second board 84 so as to facilitate the electrical connections from the lower surfaces of the second boards 84 to the printed circuit board PCB. The bottom surfaces of the middle board 81 may be exposed from the frame layer 72 so that heat may be radiated effectively to obtain a better radiation effect.

The photosensitive chip 74 is arranged on the middle board 81 of the substrate 70 and within the cavity 85. A plurality of bonding pads 86 is formed on the photosensitive chip 74. Since the horizontal height of the middle board 81 is lower than that of the first boards 82, the height of the overall package body may be greatly lowered so that the products may be miniaturized after the photosensitive chip 74 is positioned on the middle board 81. In addition, since the middle board 81 is exposed from the frame layer 72, the heat generated from the photosensitive chip 74 may be transferred to the middle board 81, which directly contacts the air to have a better radiation effect.

Each wire 76 has a first end 90 electrically connected to its corresponding bonding pad 86 of the photosensitive chip 74, and a second end 92 electrically connected to its corresponding first board 82 of the metal sheet 80. Then, signals may be transferred from the photosensitive chip 74 to the substrate 70 and then from the second boards 84 of the substrate 70 to the printed circuit board PCB.

The transparent layer 78 may be a piece of transparent glass placed on the frame layer 72 to cover the photosensitive chip 74. The photosensitive chip 74 may receive optical signals passing through the transparent layer 78.

Please refer to FIG. 5, which shows another embodiment of the invention. The transparent layer 78 is transparent glue filling into the cavity 85 defined within the frame layer 72. The transparent glue encapsulates the photosensitive chip 74, which may receive optical signals passing through the transparent layer.

To sum up, the invention has the following advantages.

1. Since the substrate 70 is formed from a plurality of metal sheets 80 serving as signal output portions, no trace has to be formed and the manufacturing costs may be lowered.

2. Since the frame layer 72 is formed by way of injection molding to encapsulate the metal sheets 80, no bonding process has to be performed. Thus, the overflowed glue at the time when a large package body is cut into a number of small package bodies may be avoided, and the production yield may be increased.

3. Since the photosensitive chip 74 is positioned on the lower middle board 81, the overall height of the package may be decreased.

4. Since the middle board 81 directly contacts the air, heat from the photosensitive chip 74 may be effectively radiated to obtain a better radiation effect.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An image sensor for being connected to a printed circuit board, the image sensor comprising:
a substrate consisting of a middle board and a plurality of spaced, symmetrical metal sheets arranged at two sides of the middle board, each of the metal sheets including a first board and a second board positioned at different heights, a horizontal height of the middle board being lower than that of the first board;
a frame layer for encapsulating the plurality of metal sheets and the middle board with the first boards, second boards and middle board of the metal sheets exposed from the frame layer, the second board being electrically connected to the printed circuit board;
a photosensitive chip positioned on the middle board of the substrate;
a plurality of wires electrically connecting the first boards of the metal sheets to the photosensitive chip; and
a transparent layer positioned on the frame layer to cover the photosensitive chip.

2. The image sensor according to claim 1, wherein the frame layer is formed from thermoplastic material by way of injection molding.

3. The image sensor according to claim 1, wherein each metal sheet further comprises a third board connecting the first board to the second board.

4. The image sensor according to claim 1, wherein the transparent layer is a piece of transparent glass.

5. The image sensor according to claim 1, wherein the transparent layer is transparent glue.

6. The image sensor according to claim 1, wherein metal sheets and the middle board are integrally formed by way of punching and pressing.

7. The image sensor according to claim 1, wherein the middle board and the second boards have the same horizontal height.
